(19) United States
(12) Patent Application Publication
(10) Pub. No.: US 2004/0055821 A1
(43) Pub. Date: Mar. 25, 2004

(54) Ladder modification accessory

(76) Inventor: Matthew J. Kruse, Watkins, CO (US)

Correspondence Address: SHERIDAN ROSS PC, 1560 BROADWAY, SUITE 1200, DENVER, CO, 80202

(21) Appl. No.: 10/666,653

(22) Filed: Sep. 17, 2003

Related U.S. Application Data
(60) Provisional application No. 60/411,627, filed on Sep. 17, 2002.

(51) Int. Cl. E06C 7/42

(52) U.S. Cl. 182/107

(57) ABSTRACT

The present invention describes a ladder modification accessory and a ladder that incorporates the principles of the accessory in an integral unit. The present invention is an apparatus that can be manufactured as part of a one-piece ladder or as a retrofit attachment that will selectively interconnect to any commercially available ladder. The ladder modification accessory provides a means for moving the ladder away from the vertical working surface while keeping the ladder stabilized and in the recommended position for maximum safety while in use.

This application claims priority to U.S. Provisional Patent application Serial No. 60/411,627, filed Sep. 17, 2002, entitled “LADDER MODIFICATION ACCESSORY”, which is incorporated by reference in its entirety herein.

### FIELD OF THE INVENTION

This application relates generally to ladders, and more particularly to ladder attachments, accessories, or modifications for positioning one end of the ladder away from a working area, such as a rain gutter on a structure, in order to provide a user a more safe and ergonomic working environment.

### BACKGROUND OF THE INVENTION

Ladders are devices for climbing, generally consisting of two long structural members operably interconnected by a plurality of equally spaced rungs. To travel from one location to a relatively higher or lower location, one simply uses the rungs as steps and hand holds. Ladders are often propped against vertical walls of structures in order to initiate repairs thereto or to preform tasks thereon, such as window maintenance, painting, or gutter installation, cleaning, and removal. Generally, a lower end of the ladder rests on the ground or other horizontal surface while the upper end is leaned against a vertical surface of the structure. In order to help ensure that the end in contact with the ground does not slip when load is applied to the rungs, thereby potentially causing injury to the user, manufacturers of ladders recommend that the angle between the ladder and the ground be approximately 70 degrees for maximum stability and safety.

It is often desirable to offset the upper end of the ladder from a structure in order to access building substructures that protrude therefrom. For example, roofs generally protrude from the main exterior walls of a dwelling, thus insuring that moisture is deposited away from the building's foundation. In order to safely work on an eave or gutter interconnected to the roof a user is required to lean unsafely backward, or prop the ladder against the gutter, thereby potentially damaging the very structure they are repairing. Alternatively, a scaffold structure may be used to perform work on over-hangs, but they are time consuming to erect and move, thus account for more labor costs.

Devices that provide the required stand-off from a structure are known in the art. However, many of these devices are complicated to install, and many are unstable. More specifically, many devices are designed to selectively interconnect with the overhang or roof, and many do not maintain the manufacturer's suggested inclination, as described above.

Yet another downfall of most stand-off devices commonly used is that they are not able to be utilized proximate to a corner of a structure. Often, workers are required to perform their duties on or near the corner of a structure. Many traditional stand-off devices are not equipped with the capability of selectively engaging the corner of a structure.

The following disclosure describes an improved stand-off device that is designed, in one embodiment, to selectively interconnect with an existing ladder in order to provide sufficient clearance between the upper end of the ladder and the structure, while maintaining the optimum angle of inclination with respect to a horizontal surface.

### SUMMARY OF THE INVENTION

The present invention describes a ladder modification accessory and a ladder that incorporates the principles of the accessory in an integral unit. More specifically, the present invention is a device that can be manufactured as part of a one piece ladder or a retrofit attachment that will fit over any commercially available ladder. The ladder modification accessory provides a means for moving the ladder away from a vertical working surface while keeping the ladder stabilized and in the recommended position for maximum safety while in use.

It is one aspect of the present invention to provide a device that allows a user to either climb or descend from a first location to a second relatively higher or lower location. More specifically, one embodiment of the present invention includes at least a left structural member and a right structural member, which are spatially oriented parallel to each other and separated from each other a predetermined distance. In addition, the structural members are operably interconnected through a plurality of rungs, which are generally evenly spaced, parallel to each other, and perpendicular to the structural members. The structural members may be of any dimension, wherein length is dictated by the distance that is to be traveled, such as the height of a roof. In addition, structural members may be equipped with extension means to allow selective height adjustments. The width and thickness of the structural member's cross section is dictated by the load carrying requirements. More specifically, the structural members are designed to carry the load of users and their equipment on the ladder, and to resist bending, thus the cross sectional dimensions are varied accordingly to fit the intended use. The rungs of the ladder are designed to provide a location for steps and handholds and/or equipment storage, wherein the weight is transmitted from the rung to the structural members. As in the design of the structural members, the intended use of the ladder will dictate the cross-sectional dimensions of the rungs. Further, the rungs may vary in dimension, for example using a combination of round and generally rectangular cross-sectioned rungs in order to provide steps and shelf-like areas upon which to rest equipment. Finally, the materials of the previously described ladder components will vary depending on strength and stiffness requirements, working environment, etc. Generally, at least one of the following, or a combination thereof, are used as manufacturing materials: steel, aluminum, wood, fiberglass, plastic, iron, or rope.

It is another aspect of the present invention to provide a ladder that is adapted to selectively interface with a generally horizontal surface on its lower end, and to interconnect with a device that provides an offset from a generally vertical surface on its other end. More specifically, one embodiment of the present invention is equipped with an attachment that is interconnected to the upper end of the ladder, which is adapted to selectively engage a vertical building surface and thus off-set the uppermost portion of the ladder therefrom. As such, a worker is provided with an increased ability to access overhangs and gutters, for example, while still maintaining a safe angle relative to the generally horizontal surface. In one embodiment of the present invention, the offset is created by interconnecting predetermined lengths of material, at a predetermined angle, onto the structural members. This interconnection is generally achieved by welding additional material onto the structural members, however other interconnection means, such as brazing, bolting, screwing, etc., may be employed. Additional rungs and/or support structure may be included between the extensions to provide additional stability. In one embodiment of the present invention, the angle between the extensions and the structural members of the ladder is between about 90 to 130 degrees, which yields an angle between the generally horizontal surface and the structural members between about 90 to 50 degrees. Preferably, the angle between the extensions and the structural members is about 110 degrees, which yields the optimum ground angle of about 70 degrees. In addition, gussets may be employed between the extensions and the structural members in order to lend additional structural stability.

It is yet another aspect of the present invention to provide a ladder offset device that be selectively interconnected to the ladder. More specifically, one embodiment of the present invention employs a selectively interconnectable device that is adapted to interface with a traditional ladder to provide the desired offset. Since this embodiment selectively interconnects with a traditional ladder, no ladder modifications are needed, and traditional manufacturing techniques may be maintained. The offset device is easy to manufacture, and since no welding or other ridged interconnection is required, compatibility of materials is not required. In a related embodiment of the present invention, the offset device is equipped with means to allow it to accommodate a plurality of ladder widths. Preferably, the structures that interconnect the extension members of the offset device are adapted to selectively increase and decrease in length, by a telescoping interconnection, for example. Thus, a single, removable device may be used on a variety of ladders, thereby reducing costs. Moreover, a selectively interconnectable offset device will aid in transporting of the system because the unconnected height profile of the combination will be reduced.

It is an aspect of the present invention to provide an offset device that be adapted to selectively interface with a corner of a structure. More specifically, one embodiment of the present invention is equipped with an area which may selectively interface with a corner of a structure, thereby allowing a worker to access multiple walls of a structure or the corner of an eave, for example, without having to continually move the ladder, or reach dangerously away from the center of gravity of the ladder. That is, traditionally, a worker would lean the ladder against one wall and attempt to access an adjacent wall, which would force him or her to lean transversely from the ladder. This leaning causes the center of gravity of the system to shift, thereby causing eccentric loading and increasing the odds of tipping. This embodiment of the present invention is adapted to selectively interface with adjacent walls, thereby ensuring a stable ladder, and greatly increasing the load required to impart tipping. Preferably, in one embodiment of the present invention, the interface area is constructed of two members that are interconnected at about a 90 degree angle. However, one skilled in the art will appreciate that any angle may be used to match the interface angle of adjacent walls. For example, geodesic domes are created by assembling a plurality of planar surfaces, which are not 90 degrees apart. In addition, the interface area may be constructed with a selectively adjustable angle, such as with a hinge, to allow for various interface possibilities. Further, an arcuate interface area may be employed in order to interface with a round structure, such as a grain silo.

It is still yet another aspect of the present invention to provide an offset device that be adapted to selectively interface with a flat vertical surface. More specifically, one embodiment of the present invention is equipped with at least one generally planar area that is adapted to contact a vertical surface. For example, one embodiment of the present invention employs two feet to interface with a vertical surface. Another related embodiment employs feet with additional length to provide additional stability. These feet may also be constructed such that they are selectively interconnected to the offset device. In any embodiment, it is envisioned that an additional material be added to the feet to provide additional resistance to slippage and additional protection to the contact surface. Preferably, one embodiment of the present invention utilizes rubber interconnected to the feet.

It is another aspect of the present invention to provide an offset device that is capable of selective length adjustments. More specifically, one embodiment of the present invention employs at least a two-piece offset device, wherein one piece is interconnected to the ladder and the other is adapted to selectively interface with a vertical surface. This second piece is also adapted to selectively interface and move relative to the first piece in order to increase or decrease the offset of the upper end of the ladder from the vertical surface. The first piece may either be rigidly or selectively interconnected to the ladder.

Thus, it is one aspect of the present invention to provide a ladder comprising:

a left structural member;

a right structural member;

a plurality of rungs interconnecting said left structural member to said right structural member;

a left extension member, positioned at a predetermined angle relative to the left structural member of the ladder;

a right extension member, positioned at a predetermined angle relative to the right structural member of the ladder;

a left vertical surface interface positioned adjacent to one end of said left extension member, and which is adapted to selectively contact the vertical surface of the structure;

a right vertical surface interface positioned adjacent to one end of said right extension member and which is adapted to selectively contact the vertical surface of the structure; and

at least one transverse support member positioned between said left extension member and said right extension member, wherein when said vertical surface interfaces are positioned on the vertical surface of the structure;, the ladder is tilted at a predetermined angle, wherein an uppermost portion of the latter is positioned a predetermined distance from the vertical surface of the structure.

The Summary of the Invention is neither intended nor should it be construed as being representative of the full extent and scope of the present invention. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention.

### BRIEF DESCRIPTION OF THE DRAWINGS

FIG. 1 is a front perspective view of one embodiment of the present invention, wherein an offset device is rigidly interconnected to a ladder;

FIG. 2 is a right elevation view of the embodiment of the present invention shown in FIG. 1;

FIG. 3 is a front perspective view of another embodiment of the present invention, wherein the offset device is selectively interconnected to the ladder;

FIG. 4 is a right elevation view of the embodiment of the present invention shown in FIG. 3;

FIG. 4a is a partial right detail view of the denoted area in FIG. 4;

FIG. 5 is a right elevation view of a selectively interconnectable offset device, which is also adapted to selectively increase and decrease in length;

FIG. 6 is a top plan view of a component of the offset device that is adapted to selectively interface with a second component of the offset device that is selectively interconnected to the ladder;

FIG. 7 is a front elevation view of the component shown in FIG. 6;

FIG. 8 is a cross sectional view of the offset device shown in FIG. 5 that includes, in part, a component that selectively interconnects with the ladder and a component that selectively interfaces therewith, thereby providing selective length adjustments;

FIG. 9 is a top plan view of an alternate component of the offset device that is adapted to selectively interface with the component of the offset device that is selectively interconnected to the ladder;

FIG. 10 is a top plan view of yet another alternate component of the offset device that is adapted to selectively interface with the component of the offset device that is selectively interconnected to the ladder; and

FIG. 11 is a right elevation view of one embodiment of the present invention shown selectively interfaced with a vertical surface of a structure and a generally horizontal surface.

### DETAILED DESCRIPTION

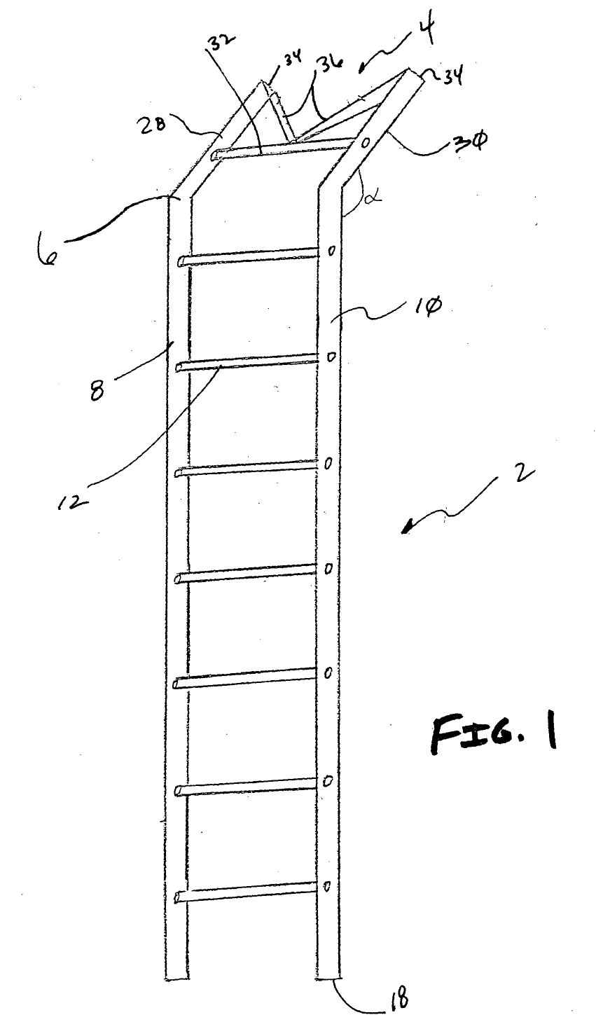

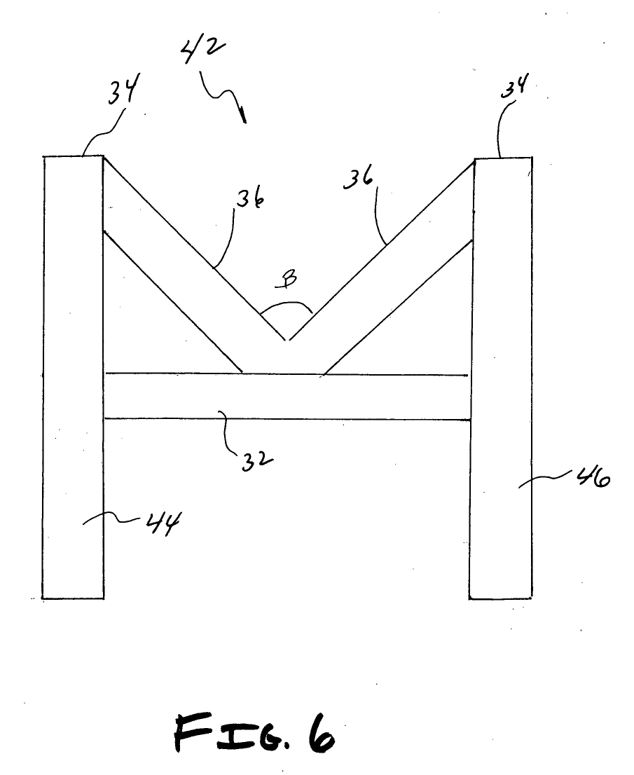

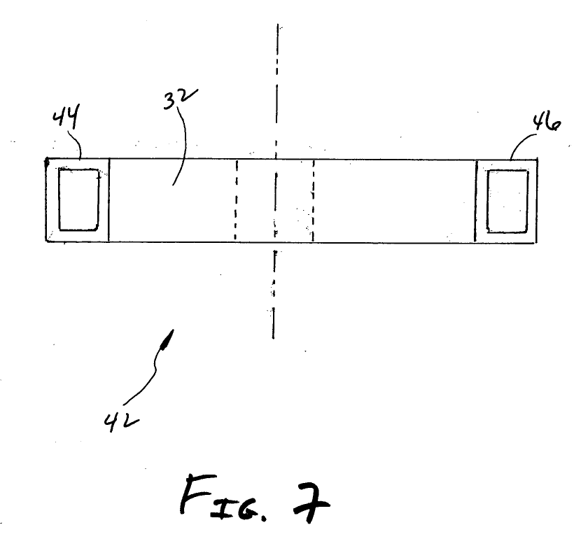

Referring now to FIGS. 1-11, a ladder 2 interconnected to an offset device 4 is generally shown herein. More specifically, an offset device 4 is shown interconnected to a ladder, either rigidly or selectively, that displaces an upper end 6 of the ladder, while maintaining a preferred angle of the ladder 2 with respect to the ground. A ladder is usually comprised of at least a left structural member 8, a right structural member 10, and a plurality of rungs 12 positioned therebetween. Generally, a ladder 2 is propped against a vertical surface 14 of a structure 16, wherein the upper end 6 is in contact with the vertical surface 14 and a lower end 18 is in contact with a generally horizontal surface 20, such as the ground. One embodiment of the present invention is equipped with an offset device 4 that is adapted to spatially displace the upper end 6 of the ladder 2 in order to provide a user greater access to gutters 22, roofs 24, or around overhangs 26, often found on structures 16, while maintaining a predetermined safe tilt angle with respect to the horizontal surface 20. Manufacturers of ladders 2 recommend that the angle between the ladder 2 and the horizontal surface 20, angle γ, be approximately 70 degrees for maximum stability and safety. The offset device 4 may be made of any rigid material, including but not limited to various metals, plastic, or wood. The material should be able to withstand the weight of a person and the weather conditions to which the device will be subjected. Preferably, the ladder modification device is made of the same material as the ladder. Most ladders are made of a form of aluminum, but one skilled in the art will appreciate that many other materials may be used to achieve the required rigidity and corrosion resistance.

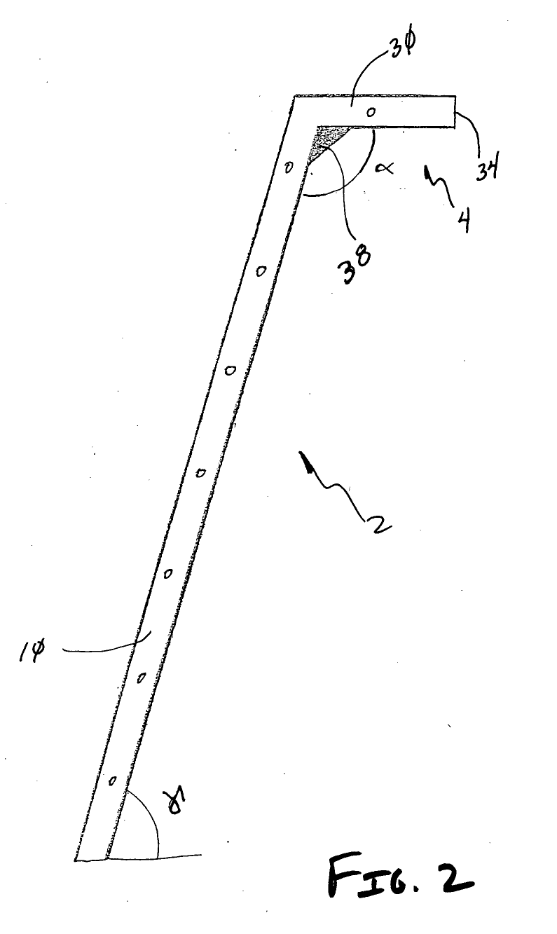

Referring now to FIGS. 1 and 2, one embodiment of the present invention that employs a rigidly interconnected offset device 4 is shown herein. More specifically, a ladder 2, which includes at least a left structural member 8, a right structural member 10, and a plurality of rungs 12 equally spaced therebetween, is interconnected to the offset device 4. The offset device 4 includes, among other things, a left structural extension 28, a right structural extension 30, transverse support members 32, vertical surface interface areas 34, and angled surface interface areas 36. Preferably, the extension members 28 and 30 are rigidly interconnected to the structural members 8 and 10 of the ladder 2 at a predetermined angle α that results in the optimum ladder tilt angle when the ladder 2 is in use. For example, for a tilt angle of 70 degrees, the offset device 4 will be positioned 110 degrees from the ladder. Generally, the offset device is welded to the ladder 2, with or without other structural enhancing means, such as gussets. However, other rigid interconnection methods may be used, such as bolting or screwing. In addition, the desired offset may be integrally manufactured into a ladder 2 in a one-piece design for maximum strength. Alternatively, the offset device 4 may be hingedly interconnected to the ladder 2 to allow for selective alterations of the offset angle α. The angle α is, preferably, an obtuse angle and can range from about 91 degrees to 179 degrees. More preferably, the angle α is about 110 degrees. The material of the offset device 4 will partly depend on the method of attachment, corrosion factors, and method of use, for example. Preferably, the same material used in construction of the ladder 2 will be used in the construction of the offset device 4.

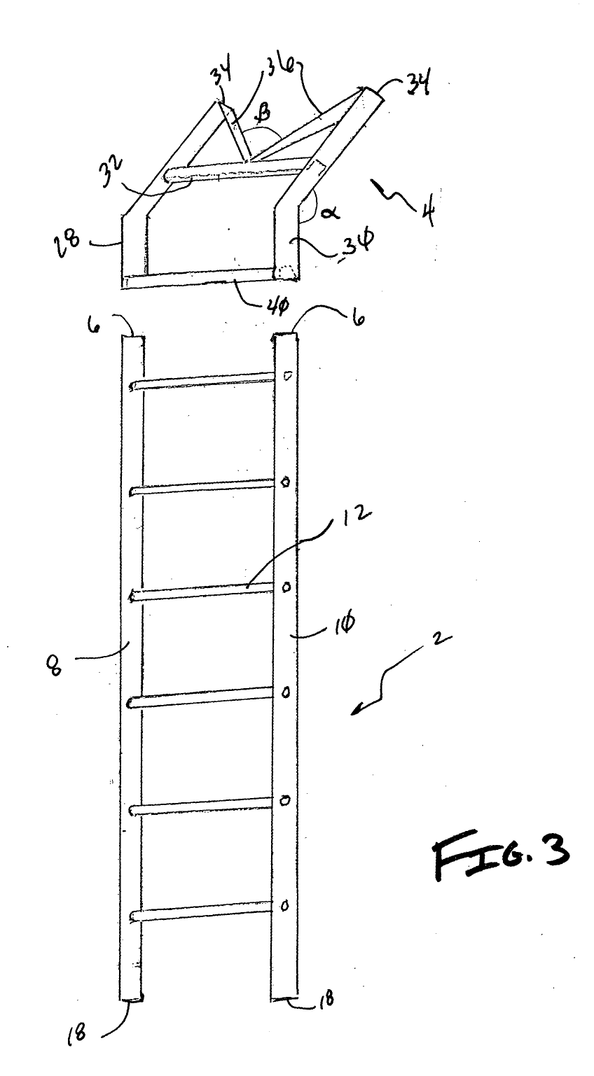

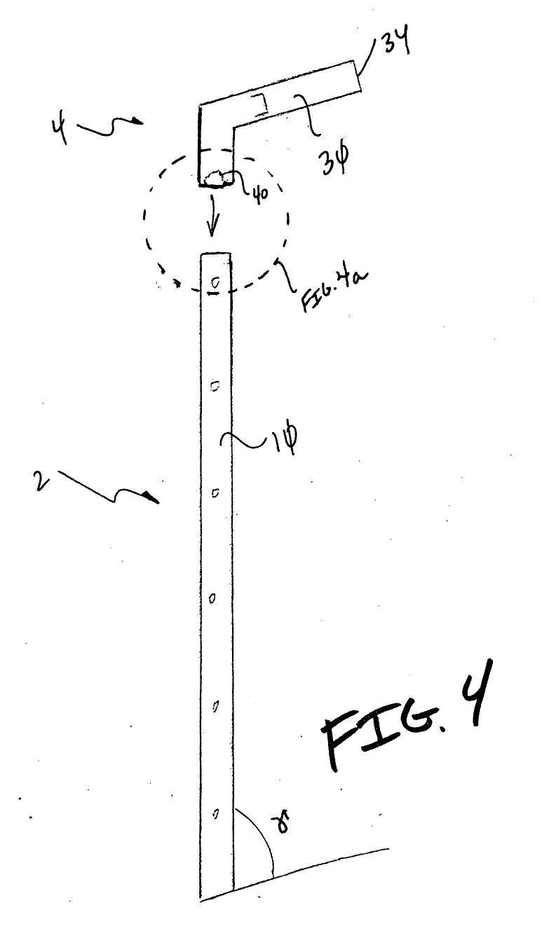

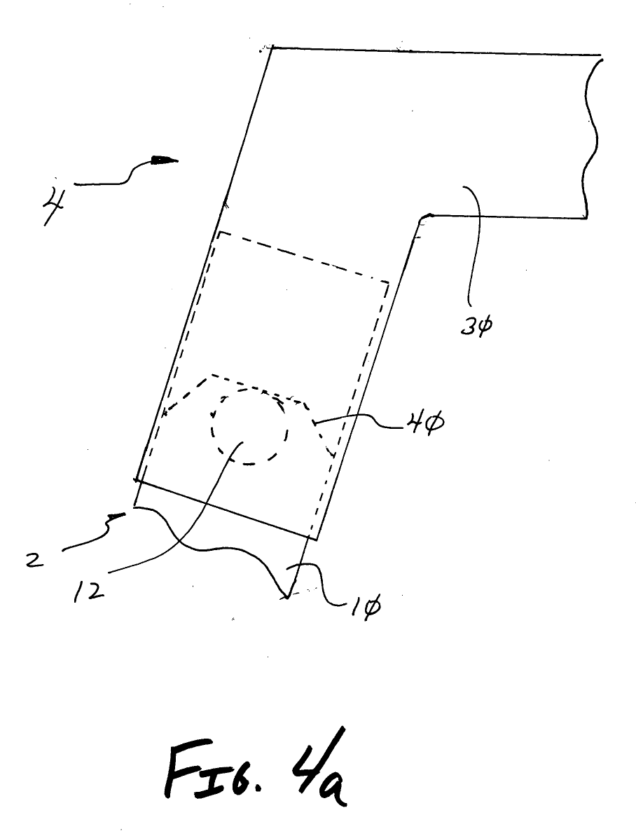

Referring now to FIGS. 3 and 4, another embodiment of the present invention is shown herein that employs a selectively interconnectable offset device 4. This embodiment of the present invention is intended to be a retrofit option that is adapted to selectively interconnect to traditional ladders 2, thereby alleviating alterations thereof. As described above, the offset device includes at least a left structural extension 28, a right structural extension 30, transverse support members 32, vertical surface interface areas 34, and angled surface interface areas 36. However, in this embodiment of the present invention, the angle α, as described above, is integrated into the two extension members 28 and 30. The angle α is, preferably, an obtuse angle and can range from about 91 degrees to 179 degrees. More preferably, the angle α is about 100 degrees to 120 degrees. In addition, a stabilizing member 40 may be included. This stabilizing member 40 is designed to selectively interface with the top rung of the ladder 2 in order to constrain the offset device 4 along the length of the ladder 2. The stabilizing member 40 can take any shape that will allow it to fit over the top rung of the ladder 2. Thus, the stabilizing member 40 can be circular, c-shaped, u-shaped, rectangular, triangular, etc. Preferably, the stabilizing member is u-shaped to allow the offset device 4 to be used with a wide variety of ladders 2 and extension ladders, which are traditionally equipped with cylindrically shaped rungs 12.

The extension members 28 and 30 are also attached to the angled surface interface area 36, which preferably adapted to fit most 90 degree corners of structures. However, any angle may be incorporated into the design, or adapters may be used to customize the area to a desired angle. In one embodiment of the present invention, the angled interface area 36 is interconnected to the extension members 28 and 30 and a transverse member 32. As shown in FIG. 1, the angled interface is comprised of two segments with each segment having a first end and a second end. The first end of each of the angled interface is interconnected to the pair of extension members 28 and 30. The second end of each of the angled interface is interconnected to a transverse support member 32. It should be appreciated that the transverse support member 32 may take any shape so long as the angled interface members 36 can be interconnected thereto. This interconnection may be achieved through various means, including but not limited to, welding, fastening, nailing, screwing, fusing, bolting, or any combination of these means so long as the connection can withstand the various forces that will be placed upon the angled members 36 when in use.

Referring now to FIG. 4a, the offset device 4 is shown installed. The extension members 28 and 30 are adapted to fit over the upper portions of the structural members 6 and 10 of the ladder 12. The extension members 28 and 30, which are preferably constructed from rectangular tubing or “C” channels, are designed to slide down over upper portions of the structural members 6 and 10 until contact is made between the upper portions and the outer internal bend of the extension members 28 and 30, or until the stabilizing member 40 rests on the top rung of the ladder.

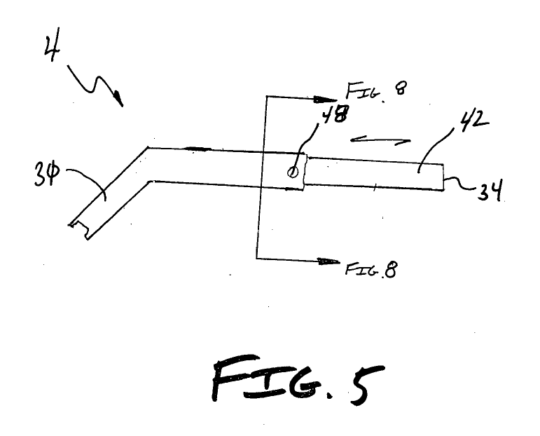

Referring now to FIGS. 5-8, another embodiment of the present invention is shown herein that employs a selective length adjustment. More specifically, the extension members 28 and 30, as previously described, are adapted to receive an extension device 42, which is designed to selectively alter the offset of the upper end of the ladder. Preferably, the extension device 42 includes at least a left tube 44 and a right tube 46 that are adapted to telescope into larger rectangular tubular members employed by the extension members 28 and 30. Alternatively, the tubular members 28 and 30 may be constructed of “C” channels that are adapted to receive the tubular members of the extension device 42. In addition, a locking mechanism 48 may be employed to selectively secure the extension device 42 at a plurality of lengths and to provide increased safety.

The extension device 42 of one embodiment of the present invention includes the left tube 44 member, a right tubular member 46, a transverse support member 32 therebetween, an angled interface area 36, and a vertical surface interface area 34. These components are generally identical as those described above, but are adapted to selectively engage the extension members 28 and 30 of the offset device 4 to provide a range of offsets to accommodate a plurality of working conditions.

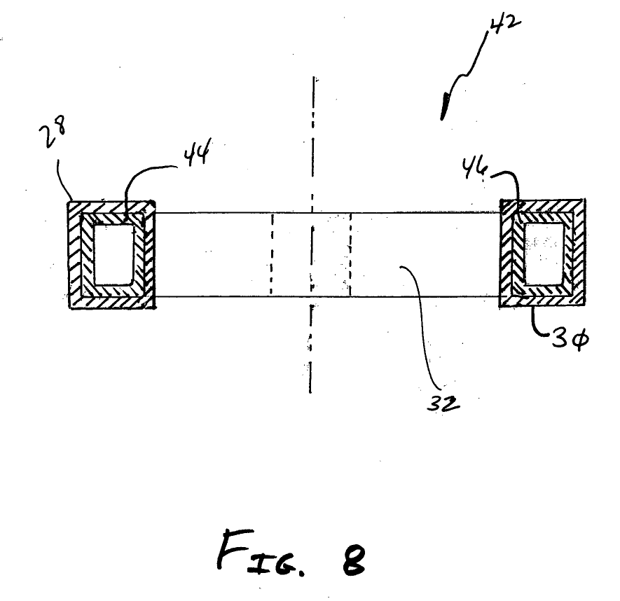

Referring now specifically to FIG. 8, a cross-sectional view of a selectively interconnected extension device 42 is shown herein. More specifically, the extension device 42 is shown surrounded by the extension members 28 and 30. Preferably, the extension members 28 and 30 are constructed from rectangular tubing or “C” channels of slightly greater dimensions than those of the extension device 42 in order to provide adjustability while maintaining stability when in use. When in the desired position, the extension device 42 is either locked in place with the locking mechanism or allowed to slide completely into the extension members 28 and 30 until it contacts the inner corner thereof.

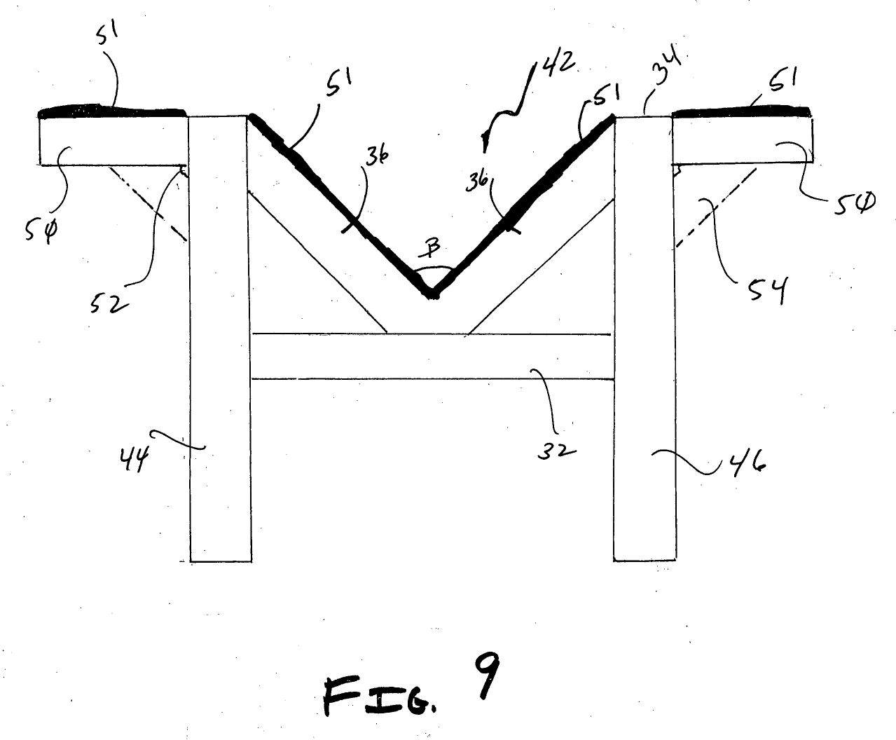

Referring now to FIG. 9, and alternate embodiment of the extension device 42 is shown herein. This embodiment is virtually identical to the embodiment previously described. In addition, feet 50 are added to increase the footprint of the extension device 42 onto the vertical surface to reduce pressure loads on the surface during use, and to provide increased surface area and thus increased frictional resistance to motion. Generally, the vertical surface interface area 34 is designed to selectively contact a wall of a structure. By increasing the footprint, the ladder is less susceptible to rocking about an axis generally parallel to the ladder's structural members. In addition, this embodiment increases the surface area such that loads are distributed more efficiently, thus less likely to cause damage to siding or glass, for example. Further, the feet 50 and the angled surface interface area 36 may include a non-slip material 51, such as rubber, to thus decrease the chance of ladder slippage during use. Preferably, the feet 50 are rigidly interconnected to the extension device 42 by welding or bolting, for example. However, a related embodiment of the present invention employs removable feet 56 to facilitate a wider variety of installation options. For example, angled feet may be employed that are more suited to engage a corner of a room. Finally, additional supports may be added, such as gussets 54, to improve stability.

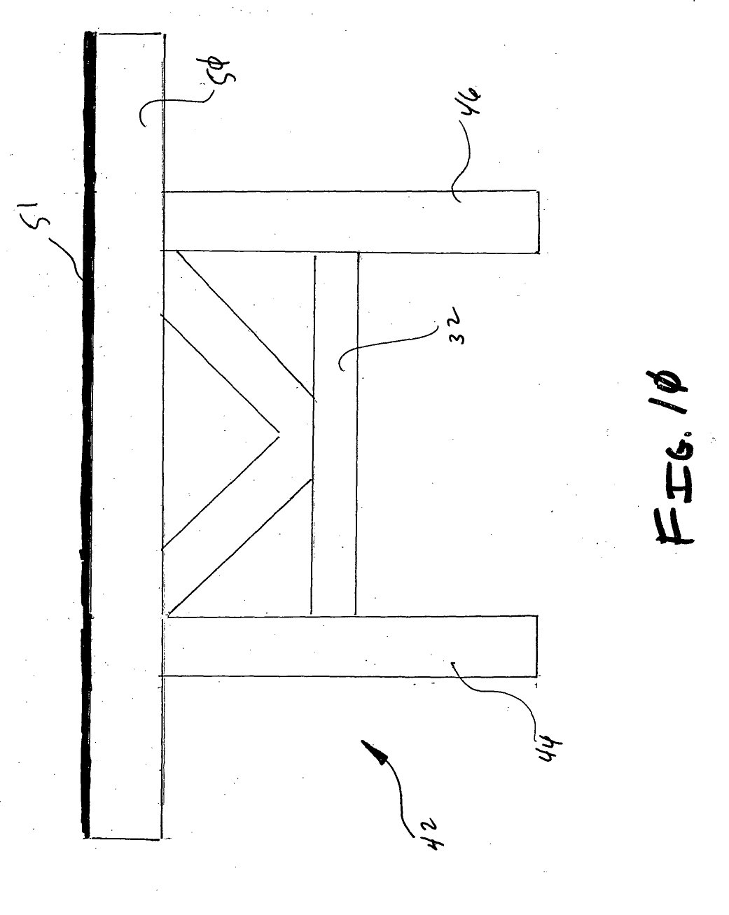

Referring now to FIG. 10, a related embodiment of the extension device 42 is shown herein. Here a single foot 50 is used to distribute loads and provide increased safety. This embodiment is substantially identical to the previously described embodiment, except only one long foot 50 is employed. Thus, this embodiment is not as suited to interface with corners of buildings, for example. In a related embodiment of the present invention the transverse support member 32 and associated structure is omitted.

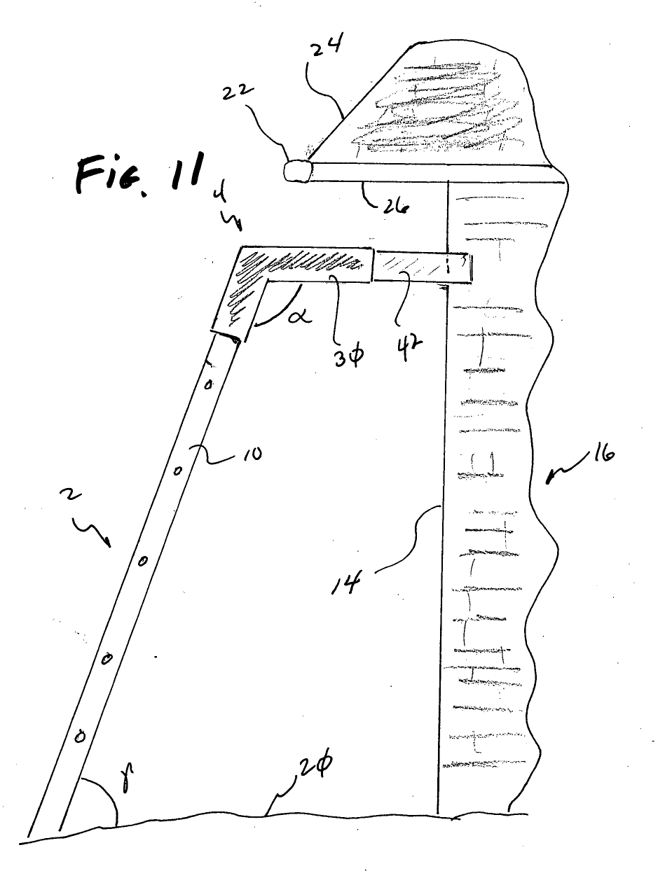

Referring now to FIG. 11, one embodiment of the present invention is shown in use. Initially, the invention will be transported to a work site. Next, the offset device 30 is selectively interconnected to the ladder 2. The amount of required offset is then calculated and the extension device 42 is adjusted accordingly. The invention is then selectively interfaced with a vertical surface 14 of a structure 16 and a generally horizontal surface 20, thus maintaining the desired tilt angle and allowing clear access to gutters, overhangs, roofs, etc. 22, 26, 24. In this figure the embodiment of the present invention that employs an adjustable offset device 42 is shown, however one skilled in the art will appreciate that installation of the other embodiments described herein is similar.

To assist in the understanding of the present invention the following list of components and associated numbering found in the drawings is provided herein:

| Component | # |
|---|---|
| Ladder | 2 |
| Offset device | 4 |
| Upper end of ladder | 6 |
| Left structural member | 8 |
| Right structural member | 10 |
| Rung | 12 |
| Vertical surface | 14 |
| Structure | 16 |
| Lower end of ladder | 18 |
| Horizontal surface | 20 |
| Gutter | 22 |
| Roof | 24 |
| Overhang | 26 |
| Left structural extension | 28 |
| Right structural extension | 30 |
| Transverse support member | 32 |
| Vertical surface interface area | 34 |
| Angled surface interface area | 36 |
| Gusset | 38 |
| Stabilizing member | 40 |
| Extension device | 42 |
| Left tube | 44 |
| Right tube | 46 |
| Locking mechanism | 48 |
| Foot | 50 |
| Non-slip material | 51 |
| Weld | 52 |
| Feet gusset | 54 |

The principles, preferred embodiments, and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the claims. While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A ladder with an offset device adapted for selective positioning against a vertical surface of a structure, comprising:
a left structural member;
a right structural member;
a plurality of rungs interconnecting said left structural member to said right structural member;
a left extension member, positioned at a predetermined angle relative to the left structural member of the ladder;
a right extension member, positioned at a predetermined angle relative to the right structural member of the ladder;
a left vertical surface interface positioned adjacent to one end of said left extension member, and which is adapted to selectively contact the vertical surface of the structure;
a right vertical surface interface positioned adjacent to one end of said right extension member and which is adapted to selectively contact the vertical surface of the structure; and
at least one transverse support member positioned between said left extension member and said right extension member, wherein when said vertical surface interfaces are positioned on the vertical surface of the structure, the ladder is tilted at a predetermined angle, wherein an uppermost portion of the latter is positioned a predetermined distance from the vertical surface of the structure.

2. The ladder of claim 1, wherein said predetermined angle of said extension members with respect to the structural members of the ladder is about 100 degrees to 120 degrees, preferably about 110 degrees.

3. The ladder of claim 1, wherein said extension members are constructed of rectangular tubes, of about the same size and material of the structural members of the ladder, and are either welded or bolted thereto.

4. The ladder of claim 1, further comprising:
a left gusset interconnected to said left extension member and to the left structural member of the ladder; and
a right gusset interconnected to said right extension member and to the right structural member of the ladder.

5. The ladder of claim 1, further comprising:
an angled surface interface member positioned between said left extension member and said right extension member, wherein said angled surface interface is adapted to selectively contact at least two adjacent walls that are joined at an angle, such as a 90 degree corner.

6. The ladder of claim 1, wherein said predetermined angle between said left extension member and said left structural member, and between said right extension member and said right structural member is adapted to be selectively adjustable.

7. An offset device adapted for selective interconnection with a ladder, that comprises a left structural member, a right structural member, and a plurality of rungs therebetween, comprising:
an angled left extension member, which is adapted to selectively interconnect with the left structural member of the ladder;
an angled right extension member, which is adapted to selectively interconnect with the right structural member of the ladder;
a left vertical surface interface adjacent to one end of said left extension member, which is adapted to selectively contact a vertical surface of the structure;
a right vertical surface interface adjacent to one end of said right extension member, which is adapted to selectively contact the vertical surface of the structure; and
at least one transverse support member interconnecting said left extension member and said right extension member, wherein said offset device may be selectively interconnected to the ladder by interfacing the left structural member of the ladder with said left extension member and interfacing the right structural member of the ladder with said right extension member, and wherein when said offset device is selectively interconnected to the ladder and said vertical surface interfaces are positioned on the vertical surface of the structure, the ladder is tilted at a predetermined angle and the uppermost portion of the ladder is positioned a horizontal distance of at least about 12 inches from the structure.

8. The offset device of claim 7, further comprising:
a stabilization member, interconnected to said left extension member and to said right extension member, which is adapted to selectively interface with the uppermost rung of the ladder.

9. The offset device of claim 7, wherein said predetermined angle of said extension members is about 100 degrees to 120 degrees, preferably about 110 degrees.

10. The offset device of claim 7, further comprising:
an angled surface interface member positioned between said left extension member and said right extension member, wherein said angled surface interface is adapted to selectively contact at least two adjacent walls that are joined at an angle, such as a 90 degree corner.

11. An offset device adapted for selective interconnection with a ladder that comprises a left structural member, a right structural member, and a plurality of rungs therebetween, comprising:
an angled left extension member, and which is adapted to interconnect to the left structural member of the ladder;
an angled right extension member, which is adapted to interconnect to the right structural member of the ladder;
an extension device adapted to selectively interconnect to said left and said right extension members, which further includes:
a left tubular member;
a right tubular member;
at least one transverse support member interconnected to said left tubular member and said right tubular member,
a left vertical surface interface positioned adjacent to one end of said left tubular member, which is adapted to selectively contact a vertical surface of a structure;
a right vertical surface interface positioned adjacent to one end of said right tubular member, which is adapted to selectively contact the vertical surface of the structure; and
an angled surface interface member positioned between said left tubular member and said right tubular member, wherein said angled surface interface is adapted to selectively contact at least two adjacent walls that are joined at an angle, such as a 90 degree corner.

12. The offset device of claim 11, further comprising a locking mechanism that is adapted to selectively interconnect with said extension device, thus fixing the location of said offset device to a predetermined value.

13. The offset device of claim 11, further comprising:
a least one footing interconnected to at least one of said left or right tubular member.
